(19) United States
(12) Patent Application Publication
(10) Pub. No.: US 2010/0275949 A1
(43) Pub. Date: Nov. 4, 2010

(54) ULTRASONIC COATING REMOVAL METHOD

(76) Inventors: Forrest R. Ruhge, Orlando, FL (US); Clifford Hatcher, Orlando, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/234,763

(22) Filed: Sep. 22, 2008

(51) Int. Cl. B08B 3/12

(52) U.S. Cl. 134/1

(57) ABSTRACT

A method for removing a coating layer from a substrate structure. The method includes the steps of positioning a sheet of interface material on the substrate structure with a first, inner face of the interface material in engagement with a predetermined area of the coating layer, and exciting a second, outer face of the interface material with an ultrasonic frequency kinetic energy. The ultrasonic energy causes the predetermined area of the coating layer in contact with the inner face of the interface Material to be substantially completely removed.

This invention was made with U.S. Government support through U.S. Government subcontract UTC 07-S508-028-C1 under prime contract F33615-03-D-5204 awarded by the U.S. Department of Defense (DOD). Pursuant to these contracts, the U.S. Government may have Certain rights to this invention.

### FIELD OF THE INVENTION

The present invention generally relates to the field of coating removal and, more particularly, to removal of coatings using ultrasonic energy.

### BACKGROUND OF THE INVENTION

Material coatings of various types are often applied to structures to provide immunity to corrosion, thermal insulation, shielding, as well as appearance enhancement, and as an aid in identification. For various types of structures and equipment, it is often necessary or desirable to remove the layer or layers of coatings which have been applied to surface areas. Numerous techniques exist for removing paint, sealants, lacquers and other adherent materials from the coated surfaces. Surface cleaning or stripping methods range from mechanical abrasion to the use of strong chemicals, and involve varying degrees of time, effort and expense. For any given type of coating, the character and function of the substrate material from which a coating is to be removed usually dictates the stripping method, at least in industrial settings. For example, abrasive methods such as sand blasting may be used to clean coatings from hard, durable surfaces, whereas more delicate surfaces may require careful chemical removal to prevent damage or destruction of the substrate surface.

The removal of paint from the surfaces of aircraft presents special problems. Such surfaces are large and may be irregularly shaped. In addition, the surfaces may comprise a relatively delicate structure due to the thickness and/or material of the surface. Because the surfaces of aircraft are typically lightweight aluminum or organically based composite materials, such surfaces and the underlying substrates are particularly susceptible to damage while undergoing paint removal that could degrade their structural integrity. For example, particle media blast cleaning processes that are energetic enough to remove hardened coatings such as paint may damage delicate surfaces such as are found on aircraft and automobiles if they are not carefully managed.

It is also known in the art to apply chemical compounds to painted surfaces in order to chemically breakdown the layers of paint, thereby stripping the paint away from the surface to be exposed. However, such compounds may be inappropriate for the removal of protective coatings from non-metallic organic matrix composite materials.

Mechanical paint removal techniques are also known in the art. For example, U.S. Pat. No. 4,836,858, entitled “Ultrasonic Assisted Paint Removal Method” discloses a hand held tool which uses an ultrasonic reciprocating edge placed in contact with the surface to be stripped. However, this technique requires engaging the surface with a scraping or abrasive surface that may damage the surface if not operated properly.

### SUMMARY OF THE INVENTION

In accordance with one aspect of the invention, a method is provided for removing a coating layer from a substrate structure. The method comprises the steps of: positioning a sheet of interface material on the substrate structure with a first, inner face of the interface material in engagement with a predetermined area of the coating layer; exciting a second, outer face of the interface material with an ultrasonic frequency kinetic energy; and wherein the predetermined area of the coating layer in contact with the inner face of the interface material is substantially completely removed.

In accordance with another aspect of the invention, a method is provided for removing a coating layer, defined by a layer of paint, from a substrate structure. The method comprises the steps of: positioning a friction material pad on the substrate structure with a first, inner face of the pad in engagement with a predetermined area of the coating layer; applying a predetermined pressure with the inner face against the predetermined area of coating material; and exciting a second, outer face of the pad with an ultrasonic frequency kinetic energy, causing the coating material to detach from the predetermined area for effecting a substantially complete removal of the coating material in the predetermined area.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a diagrammatic illustration of an apparatus configured to perform the process of the present invention;

FIG. 2 is a perspective view illustrating a coating removal process in accordance with the present invention; and

FIG. 3 is a perspective view illustrating a preparation step for the present coating removal process including providing an interface pad shaped to a predetermined configuration.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

The present invention provides a method and apparatus for removing coating materials from a substrate in an efficient manner which reduces work time on the coating material and substantially avoids adverse abrasive affects.

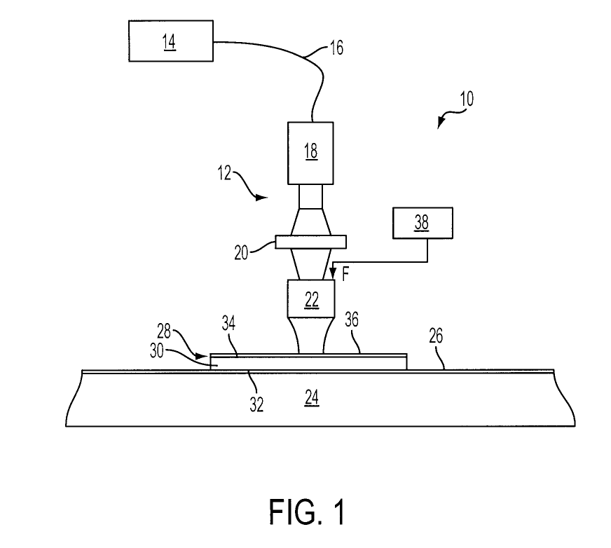

Referring initially to FIG. 1, an apparatus 10 for performing a process in accordance with the present invention is illustrated. The apparatus 10 includes an ultrasonic energy source 12 comprising a power supply 14 which provides electrical high frequency power at a predetermined ultrasonic frequency via a cable 16 to an electro-acoustic transducer 18. The electro-acoustic transducer 18 provides mechanical vibrations at the predetermined ultrasonic frequency to a booster or coupling horn 20 for coupling the vibrations to a resonant horn 22. The predetermined ultrasonic frequency may be a frequency of approximately 20 kHz. The ultrasonic energy source 12 may be of the type commonly used for ultrasonic welding processes. For example, the ultrasonic energy source 12 may comprise a Branson 2000 series system available from Branson Ultrasonics Corporation, Danbury, Conn.

The ultrasonic energy source 12 is located adjacent to a substrate structure 24 having a coating layer 26, at least a portion of which is to be removed from the substrate structure 24. An interface pad structure 28 is located between the resonant horn 22 of the ultrasonic energy source 12 and the substrate structure 24. The pad structure 28 comprises an interface material 30, illustrated as being formed as a substantially planar board-like member. The interface material 30 includes a substantially planar first, inner surface 32 provided for engagement with a predetermined area of the coating layer 26, and a second outer surface 34 for being excited by an ultrasonic frequency kinetic energy from the resonant horn 22. Optionally, the pad structure 28 may include a transmission member 36 comprising a sheet of material having a high transmissivity to ultrasonic energy located at the outer surface 34 between the interface material 30 and the resonant horn. The transmission member 36 is provided to convey the ultrasonic frequency kinetic energy to areas of the interface material 30 spaced from an end of the resonant horn 22 and may comprise a metal sheet, such as a sheet of aluminum.

The resonant horn 22 may be urged toward engagement with the interface pad structure 28 by a force means, generally indicated at 38, provided as a component of the apparatus 10 and acting on the resonant horn 22 with a predetermined force F. In a practical application of the invention, a force F of 200-500 N may be applied, although lesser or greater forces are believed to be operable to produce the results of the invention described herein. The force means 38 may comprise a known actuator, such as a Branson ae actuator, available from Branson Ultrasonics Corporation, Danbury, Conn.

The inventors have discovered that providing an interface material 30 comprising a friction material provides an unexpected result of causing the coating layer 26 to detach from the substrate structure 24, substantially removing all of the coating layer 26 in contact with the inner surface 32 in a very short time period, e.g., within approximately one second. In a preferred embodiment, the interface material 30 is formed of a brake or clutch lining material such as is known for use in vehicle brakes and clutches. For example, an operable interface material 30 comprises a ¼ inch thick, low-friction molded brake lining sheet item no. 3976K13, available from McMaster-Carr, Princeton, N.J., and having a coefficient of friction of 0.14. It should be noted that although a friction material having a coefficient of friction of approximately 0.14 is believed to satisfactorily perform the invention, other friction materials having different coefficients of friction, such as a material having a higher coefficient of friction, may provide equal or better results. However, using a material having a higher coefficient of friction may result in heating of the material of substrate structure 24 to a temperature that is higher than desired.

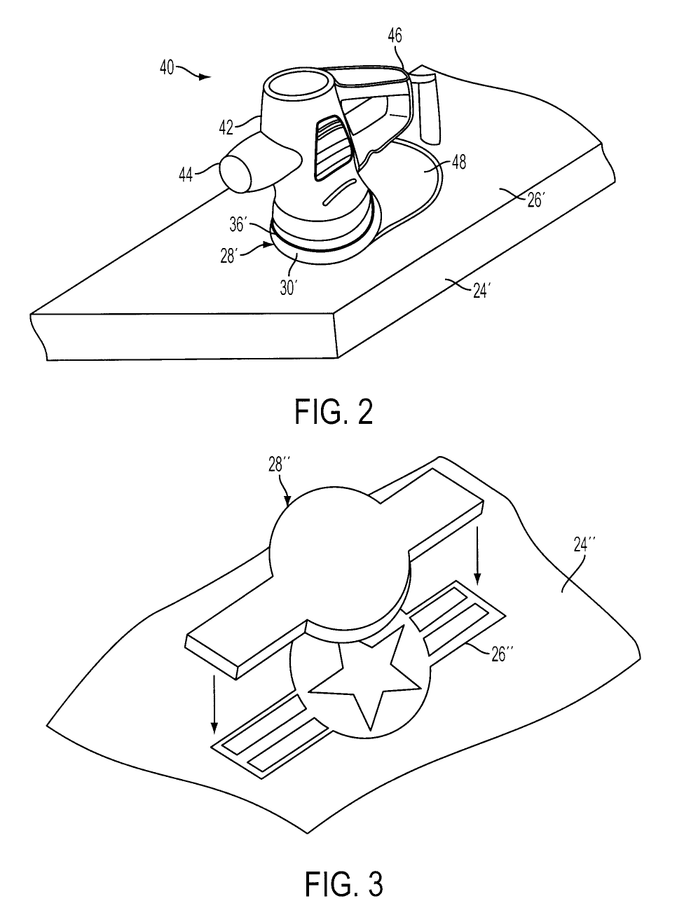

Referring to FIG. 2, the process of the invention is illustrated with an alternative apparatus 40. It should be noted that the previously described apparatus 10 of FIG. 1 may comprise a stationary device, where the substrate structure 24 is moved into position relative the ultrasonic energy source 12, whereas the apparatus 40 of FIG. 2 is provided as a portable device for positioning into association with a substrate structure 24′. The apparatus 40 includes a housing 42 for enclosing components similar to those described for the ultrasonic energy source 12 including, for example, a power supply, an electro-acoustic transducer, a booster or coupling horn and a resonant horn (not shown). Alternatively, the apparatus 40 may comprise an electro-acoustic transducer connected to a single component that performs the functions of the booster, resonator horn and transmission member. The apparatus 40 may incorporate a known portable ultrasonic energy source, such as a portable SIEMAT acoustic thermography unit, available from Siemens Power Generation, Orlando, Fla. The apparatus 40 further includes an interface pad structure 28′ that is preferably rigidly connected to the resonant horn. The interface pad structure 28′ comprises an interface material 30′, and may optionally include a transmission member 36′. The interface pad structure 28′ is formed of the same materials as described for the interface pad structure 28 of FIG. 1. Although the interface pad structure 28′ is illustrated as comprising a generally disk-shaped member, it should be understood that the pad structure 28′ may be formed with other shapes.

The apparatus 40 further includes a first handle structure 44 and a second handle structure 46. The handle structures 44, 46 provide a means for an operator to grip the apparatus 40 and move the apparatus 40 to desired locations relative to the substrate structure 24′ in order to remove a coating layer 26′ from the substrate structure 24′. During a cleaning process using the apparatus 40, the interface pad structure 28′ is located in engagement with a selected or predetermined location on the coating layer 26′, i.e., resting on the exposed surface of the coating layer 26′. The apparatus 40 is activated by the operator to transmit ultrasonic frequency kinetic energy into the interface pad structure 28′, e.g., applying ultrasonic kinetic energy at 20 kHz, while the operator applies a downward pressure on the handles 44, 46. The apparatus 40 is held in a stationary location for a short time period, such as approximately one second, to substantially remove the entire coating layer under the interface material 30′, as illustrated by the area 48 defining a location where the interface material 30′ previously contacted the coating layer 26′ and comprising a substantially clean or exposed surface of the substrate structure 24′. Subsequently, the apparatus may be lifted and placed at a new location, such as adjacent to the cleaned area 48 to further clean the coating material 26′ from the substrate structure 24′. In this manner a large surface may be efficiently cleaned of the coating material 26′ by a portable apparatus. For example, the present apparatus 40 may be used to remove paint from an aircraft surface where it is typically desirable to ensure that complete paint removal is performed without damaging the underlying substrate surface.

Referring to FIG. 3, a further step for incorporation in the process of the present invention is illustrated. A further interface pad structure 28″ is illustrated, formed with the same structure as described for the interface pad structure 28, and shaped to clean a predetermined shape on a coating layer of a substrate structure 24″. Specifically, FIG. 3 illustrates a side of an aircraft forming the substrate structure 24″ and including an insignia defining a coating layer 26″ to be removed. The interface pad structure 28″ is illustrated as being shaped to conform to the shape of the insignia coating layer 26″ to remove only the insignia 26″ from the aircraft substrate structure 24″, and may be used for repetitive operations on multiple insignias of similar shape and size.

The interface pad structure 28″ may be mounted to a portable apparatus, such as the apparatus 40, or may be used in conjunction with a separately provided ultrasonic energy source. Providing an interface pad structure 28″ having a predefined shape facilitates positioning the interface pad structure 28″ at a stationary position relative to the substrate structure 24″ during cleaning of the entire predetermined area, and permits efficient and controlled removal of a coating layer from the predefined area in contact with the planar inner surface without adversely affecting surrounding coating layer areas that are to remain in place on the substrate structure during the cleaning process.

It should be noted that when the transmission member 36 is provided in position over the outer side 34 of the interface material 30 in any of the above embodiments, the transmission member 36 may be bonded to the outer surface 34 to form the interface pad structure 28 as an integral structure. Alternatively, the transmission member 36 may be provided as a separate element that is placed in engagement with the outer surface 34 prior to application of the ultrasonic frequency kinetic energy from the ultrasonic energy source.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for removing a coating layer from a substrate structure, the method comprising the steps of:
positioning a sheet of interface material on the substrate structure with a first, inner face of the interface material in engagement with a predetermined area of the coating layer;
exciting a second, outer face of the interface material with an ultrasonic frequency kinetic energy; and
wherein the predetermined area of the coating layer in contact with the inner face of the interface material is substantially completely removed.

2. The method of claim 1, wherein the interface material comprises a substantially planar sheet that is maintained at a substantially stationary position on the predetermined area of the coating layer during the step of exciting the interface material.

3. The method of claim 2, wherein the predetermined area of the coating layer is removed within approximately one second of initiating the step of exciting the interface material.

4. The method of claim 2, wherein prior to the step of positioning the sheet of interface material on the substrate structure, shaping the interface material to conform to the shape of the predetermined area of the coating material.

5. The method of claim 1, wherein the interface material comprises a friction material.

6. The method of claim 5, wherein the inner face of the friction material has a coefficient of friction of approximately 0.14.

7. The method of claim 5, wherein prior to the step of exciting the interface material, placing a material of high ultrasonic transmissivity over the outer face of the interface material.

8. The method of claim 7, wherein the material of high ultrasonic transmissivity comprises a metal sheet.

9. The method of claim 1, wherein the ultrasonic frequency kinetic energy comprises a frequency of approximately 20 kHz.

10. The method of claim 1, wherein the coating layer comprises a layer of paint on the substrate structure.

11. A method for removing a coating layer, defined by a layer of paint, from a substrate structure, the method comprising the steps of:
positioning a friction material pad on the substrate structure with a first, inner face of the pad in engagement with a predetermined area of the coating layer;
applying a predetermined pressure with the inner face against the predetermined area of coating material; and
exciting a second, outer face of the pad with an ultrasonic frequency kinetic energy, causing the coating material to detach from the predetermined area for effecting a substantially complete removal of the coating material in the predetermined area.

12. The method of claim 11, wherein the pad is maintained at a substantially stationary position on the predetermined area of the coating layer during the step of exciting the interface material.

13. The method of claim 11, wherein prior to the step of positioning the pad on the substrate structure, shaping the pad to conform to the shape of the predetermined area of the coating material.

14. The method of claim 11, wherein prior to the step of exciting the pad, placing a material of high ultrasonic transmissivity over the outer face of the pad.

15. The method of claim 14, wherein the material of high ultrasonic transmissivity comprises a metal sheet.

16. The method of claim 13, wherein the ultrasonic frequency kinetic energy comprises a frequency of approximately 20 kHz.

17. The method of claim 11, wherein the inner face of the friction material pad has a coefficient of friction of approximately 0.14.
